(19) United States
(12) Patent Application Publication
(10) Pub. No.: US 2018/0306634 A1
(43) Pub. Date: Oct. 25, 2018

(54) AUTOMATIC HYSTERESIS CORRECTION FOR ELECTROMECHANICAL LEVEL GAUGES

(71) Applicant: HONEYWELL INTERNATIONAL INC., MORRIS PLAINS, NJ (US)

(72) Inventor: RICHARD VAN DIJK, HILLEGOM (NL)

(21) Appl. No.: 15/492,789

(22) Filed: Apr. 20, 2017

(51) Int. Cl. G01F 25/00; G01F 23/00

(52) U.S. Cl. CPC G01F 25/0076; G01F 23/0023

(57) ABSTRACT

An automatic hysteresis compensated method of level measuring a liquid in a tank includes providing an electromechanical liquid level gauge including a controller with a processor, a displacer on a wire from a measuring drum with a motor, where the processor controls a movement of the motor and executes a level gauging algorithm. A measured force displacer position (FS) profile is provided including a move-down FS curve determining Fd, Sd corresponding to a displacer center when moving down and a move-up FS curve to determine Fu, Su corresponding the displacer center when moving up. The algorithm provided a time derivative of F is essentially zero, initiates performing a down/up dip of the displacer moving the displacer down/up to below/above the liquid level, then moving the displacer up/down passing Su/Sd, then moving the displacer to return to Sd/Su, and determining the current liquid level from Fd/Fu upon the return to Sd/Su.

### FIELD

Disclosed embodiments relate to electromechanical liquid level gauges that use the servo principle.

### BACKGROUND

Electromechanical liquid level servo gauges (ESGs) are used for the accurate measurement of product level and the interface level in bulk storage tanks used for typical hydrocarbons (often referred to as fuel and oil) and a variety of other liquid chemicals. These products range from very light chemicals, like so-called LPG's (mixtures of propane and butane or even liquefied natural gas (LNG)) to all types of refined products such as naphtha, gasoline, diesel, jet fuels, lubricants and all types of chemicals, both pure and mixed.

The servo principle is based on the measurement of the apparent weight of a displacer that is within the tank. The displacer is a mechanical body suspended on a strong thin measuring wire, where the displacer material has a higher density than the liquid to be level measured. The measurement wire is wound on a high accuracy machined grooved drum with a calibrated circumference. The apparent weight resulting from the weight of the displacer minus the weight of the displaced liquid product is measured as a torque which is then used by a computing device such as a microcontroller with the servo motor used to rotate drum in order to position the displacer at a different height in the tank.

By rotating the drum the wire is spooled up or ‘paid’ out into the tank and the displacer is raised or lowered until the measured apparent weight equals the programmed set point. For safety reasons typically a magnetic coupling (using pole pairs) may be located between drum and electronics (motor, microcontroller, electronics, etc.) as many of the liquids products which are commonly stored in bulk storage tanks are flammable and typically need an explosion-safe design. The displacer being denser as compared to the density of the product in the tank is basically kept at the same level using Archimedes law which indicates that the upward buoyant force that is exerted on a body immersed in a fluid, whether fully or partially submerged, is equal to the weight of the fluid that the body displaces.

The apparent weight resulting from the displaced liquid is dependent on the density of the displaced liquid and the amount of the displaced liquid. The amount of the displaced liquid depends again on the shape of the displacer, and the set point (i.e. how much weight there needs to be displaced).

Vapor influence caused by dense vapors, especially on products with low dielectric constant and a relative high dipole moment result in accuracy limiting physics, generally making radar unsuitable and unacceptable for legal metrology use. The large variation in saturation which are not predictable also makes it generally not possible to compensate for these vapor effects, which especially occur with light hydrocarbons and chemicals, where ESGs do not have these limitations. Some examples are LPGs, ethanol and multiple industrial solvents. Also foam is an example where an ESG still can detect the liquid surface while radar will generally not find any reflection. This means that ESGs are still an important and much relied upon accurate measurement technology, especially when high and certified accuracy is a need, such as for custody transfer applications.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize for known ESGs the displacer will actively follow the level in the tank with a measurement control loop involving the force transducer and servo motor. This results in small movements of the displacer to overcome the static and dynamic friction which consumes electric power that heats the mechanics inside the ESG. This friction introduces a hysteresis effect between the force and position of the displacer which the control loop tries to reduce in a series of correction steps that typically degrades the level measurement accuracy of the ESG. The hysteresis as known in the art also varies for each ESG and over its operational lifetime.

Disclosed embodiments solve the above-described problems by providing ESGs which include automatic hysteresis corrected level measurement for liquid product(s) in bulk storage tanks. Disclosed level sensing performs an ‘entire down-dip’ (defined below) when the liquid level is essentially unchanging (defined herein as changing ≤0.1 mm/sec) which is used along with a measured (Frequency (F), Displacer position (S)) FS profile including a ‘move-down curve’ (defined below) and a ‘move-up curve’ (defined below) to calculate a current liquid level. For clarity as used herein an FS profile includes both a move-down FS curve and move-up FS curve (see FIG. 3A described below which shows an FS profile by identifying both a move-up FS curve and a move-down FS curve).

The method also includes calculating a correction to the level reading responsive to pumping in/expanding or pumping out/shrinking of liquid in a mode referred to herein as a ‘hold and correct mode’. Disclosed methods automatically compensate for the hysteresis caused by static and dynamic friction by keeping track of the location on the move-down and move-up curve (which spans up the entire hysteresis curve) under changing conditions. There is thus no need to explicitly measure the hysteresis, and disclosed methods have essentially no drift in the measured liquid level.

There are several displacer movements used in disclosed level sensing referred to herein as “dips” that are defined below, where as noted above S stands for the displacer position and F for the measured force:

1. An ‘entire down-dip’ starts with the displacer suspended completely (entirely) above liquid level. The displacer is moved down to a position so that it is completely below the liquid level. The displacer is moved up again to a position passing the calculated liquid level Su (Su being the middle of the height of the displacer while moving the displacer up (u)) entirely above the liquid. The displacer is again moved down to the calculated liquid level Sd (being the middle of the height of the displacer while moving the displacer down (d)), and stops moving so that the displacer is then on the move-down FS curve.
2. An ‘entire up-dip’ starts with the displacer at a position immersed entirely below the liquid level. The displacer is moved up to a position entirely above the liquid level. The displacer is moved down again at a position passing the calculated liquid level Sd entirely below the liquid. The displacer is moved up to this calculated liquid level Su and stops moving. The displacer is then on the move-up FS curve.
3. A ‘partial down-dip’ moves down the displacer to a position that is not entirely below the liquid level. The displacer is moved up again passing the calculated liquid level Su but not entirely above the liquid. The displacer is moved down to the calculated liquid level Sd and the displacer is stopped moving. The displacer is then on the move-down FS curve.
4. A ‘partial up-dip’ moves up the displacer at a position that is not entirely above the liquid level. The displacer is moved down again passing the calculated liquid level Sd but not entirely below the liquid. The displacer is moved up to the calculated liquid level Su and is stopped moving. The displacer is then on the move-up FS curve.

Disclosed embodiments include an automatic hysteresis compensated method of level measuring a liquid in a storage tank. An ESG is provided including a controller having a processor, a displacer suspended on a measuring wire from a measuring drum for causing a torque on the drum having a servo motor coupled to rotate the drum arranged to balance a weight of the displacer, where a change in liquid level causes a change in a counterforce to move the ESG out of balance. The processor monitors an output of a sensor that senses the torque and then in response controls a movement of the motor. The processor includes an associated memory storing a disclosed level gauging algorithm.

A measured FS profile is provided including a move-down FS curve obtained from moving the displacer to entirely down into the liquid to determine Fd, Sd set points on the move-down curve corresponding to a center of the displacer when moving down and a move-up FS curve from moving the displacer entirely up out of the liquid to determine Fu, Su set points on the move-up curve corresponding to a center of the displacer when moving up. The algorithm implements provided a time derivative of F is essentially zero performing a move down-dip of the displacer (including starting with the displacer suspended completely the liquid level and moving the displacer down to entirely down into the liquid level) or a move up-dip of the displacer (including starting with the displacer suspended below the liquid level and moving the displacer up to completely above the liquid level), then for the move down-dip moving the displacer up passing Su or for the move up-dip moving the displacer down passing Sd, and for the move down-dip then moving the displacer to return to Sd or for the move up-dip then moving the displacer to return to Su. A current liquid level is then determined from Fd upon the return to Sd or from Fu upon the return to Su depending on the calibrated (reference) curve used.

Thus for the determining step using the move-down curve as the reference curve for S to be measured, the current liquid level obtained from Fd using a move down-dip equals Sd. If the current liquid level is obtained from Fu (using a move up-dip), it equals Su−ΔSdu. (See FIG. 5A described below showing these parameters).

### BRIEF DESCRIPTION OF THE DRAWINGS

FIG. 1A is a depiction of an example ESG implementing automatic hysteresis level corrected liquid level measurement, according to an example embodiment.

FIG. 1B is a block diagram of an example ESG implementing automatic hysteresis level corrected liquid level measurement, according to an example embodiment.

FIG. 2 shows a point on the move-down FS curve (Fd, Sd) and a point on the move-up curve (Fu, Su).

FIG. 3B shows how L is defined herein, and FIGS. 3A, C and D show example move-up and move-down FS curves for an entire down-dip shown as step 1, S correction shown as step 2, and a partial up-dip shown as step 3, respectively.

FIG. 4 is a flow chart for an example automatic hysteresis compensated method of measuring liquid level in a storage tank, according to an example embodiment.

FIG. 5A shows an example FS profile for a displacer in a tank with a liquid therein for a range of travel showing a move-down FS curve and a move-up FS curve thus showing hysteresis.

FIG. 5B is an example state diagram showing a more detailed description of the states (locations on FS hysteresis curves as shown in FIG. 5A) the displacer can be a function of F and S.

FIG. 5C shows the four dip-types disclosed herein, their start location relative to the liquid level, direction change, movement length and the relation with the FS-plane.

FIGS. 6A-C show state diagram states changes due to dF(t)/dt changing caused by the rise or fall of liquid in the tank. One state is a point (locations A-D in FIG. 5A/B) on the hysteresis curve (F, S). Three main scenarios are shown being a liquid rise in FIG. 6A resulting in two partial down-dips where Sd goes to Sd′ which goes to Sd″ in the second partial down-dip, a liquid fall in FIG. 6B with starting point A so a partial move up must be done (two times also when F>Fu+ΔFmax and Su becomes Su′) and liquid rise with in-between liquid fall in FIG. 6C.

FIG. 7 shows an example displacer having a symmetrical shape.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

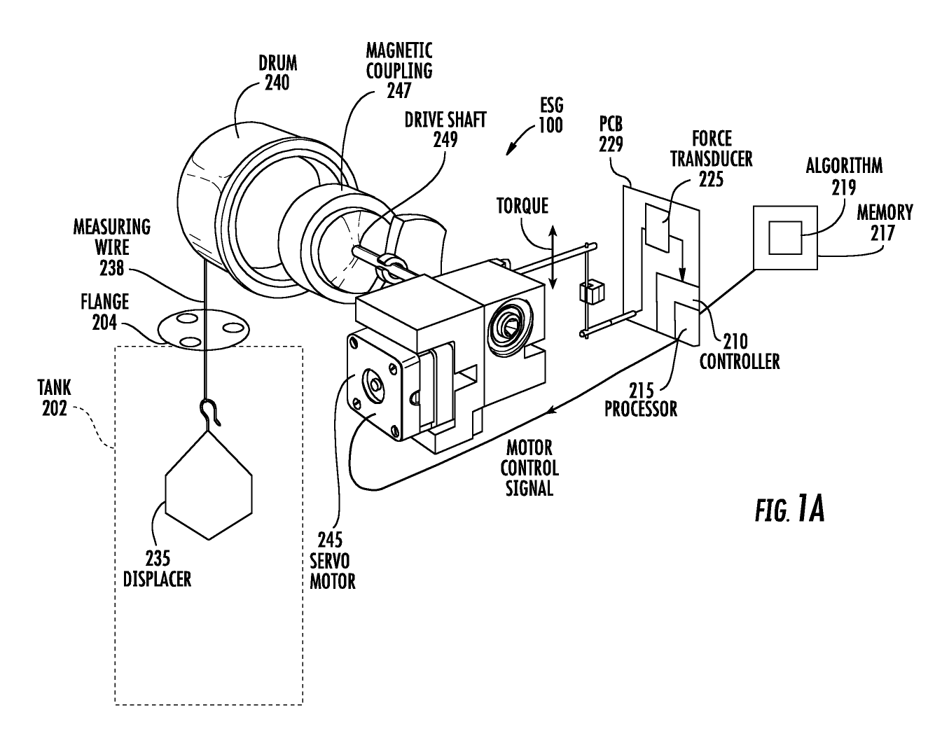

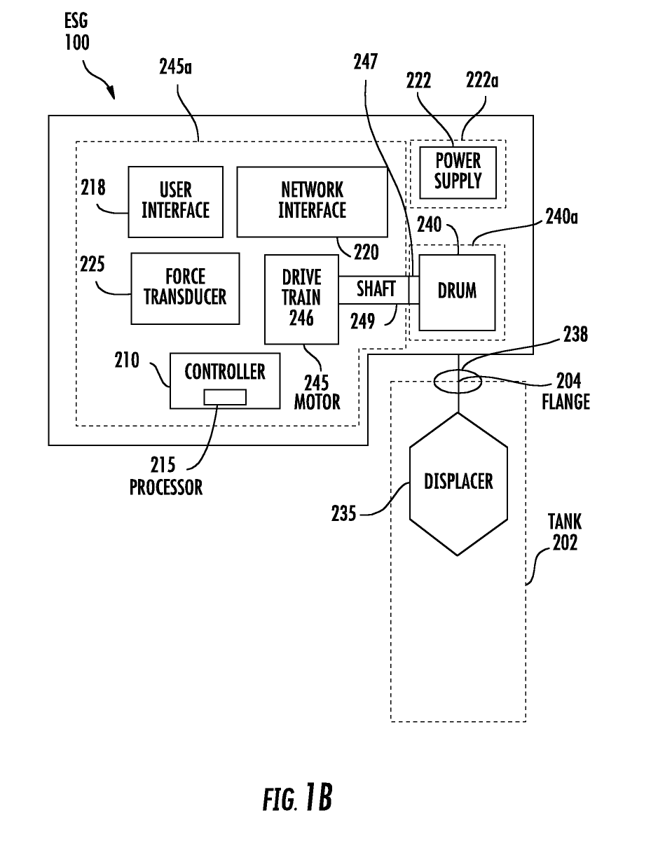

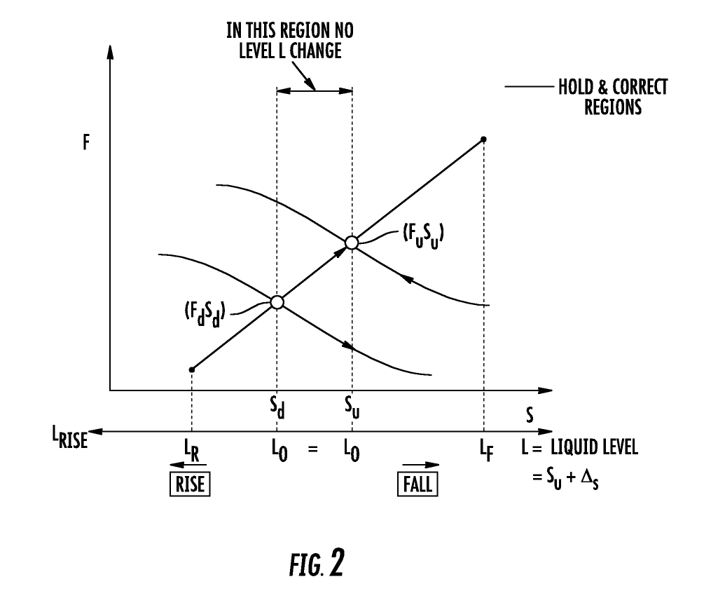

FIG. 1A shows an example ESG 100 that includes a controller 210 comprising a processor 215 having an associated memory 217 storing code for a disclosed hysteresis corrected level gauging algorithm 219 having code for implementing the algorithm, according to an example embodiment. The processor 215 can comprise a microprocessor, microcontroller (MCU), field programmable gate array (FPGA), digital signal processor (DSP), or other processing or control device. It may also be possible to implement a disclosed algorithm with hardware comprising digital logic as an alternative to a software/code-based algorithm solution. A force transducer 225 is shown on a common PCB board 229 with the processor 215. The force transducer 225 can convert a torque on the drum 240 into frequency (f) that is coupled to an input of the controller 210 acting as a Servo Processor Unit (SPU) which renders a torque measurement.

ESG 100 includes a displacer 235 within a tank 202 that has a flange 204. The displacer 235 is suspended on a measuring wire 238 from a drum 240 that extends through the flange 204 for causing a torque on the drum 240. The displacer shape and displacer dimensions are generally known. A servo motor with a gear (servo motor) 245 is coupled by a drive shaft 249 to rotate the drum 240 to balance a weight of the displacer 235 in the tank 202 having a liquid therein (not shown). An equilibrium condition exists when the displacer 235 is at a top surface of the liquid, wherein a change in the liquid level causes a change in a counterforce to move the ESG 100 out of balance. As noted above, although not shown, any force which acts via the measuring wire 238 on the drum 240 sensed by force transducer 225 can be transferred as a torque to processor side of the ESG 100 using a magnetic coupling 247.

After moving down the displacer 235 entirely under the level, (a move down FS curve), the displacer's middle needs to be placed essentially exactly on the interface level for an accurate level measurement. However, because of the change of direction by moving the displacer 235 up, a hysteresis effect is caused by friction which needs correction for level measurement accuracy. This hysteresis effect is known to vary between individual ESG instruments because of production variation and over an ESG's lifetime. It is recognized the hysteresis effect is fortunately identical with the direction change of the displacer moving down/up or moving up/down.

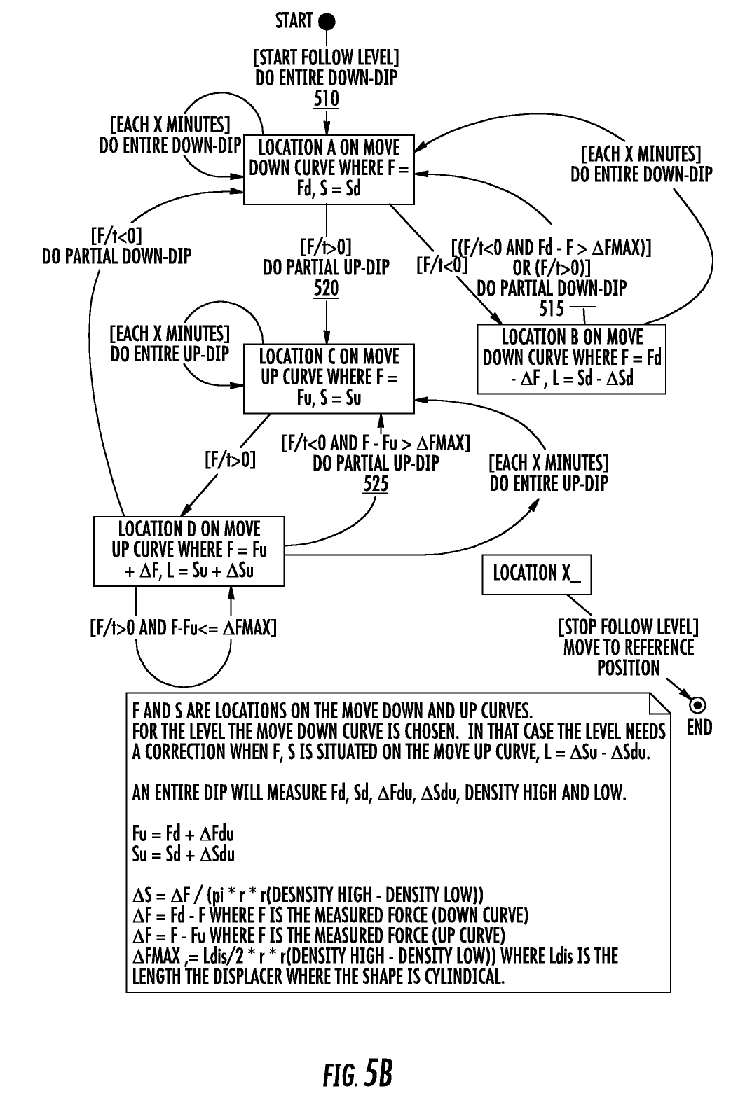

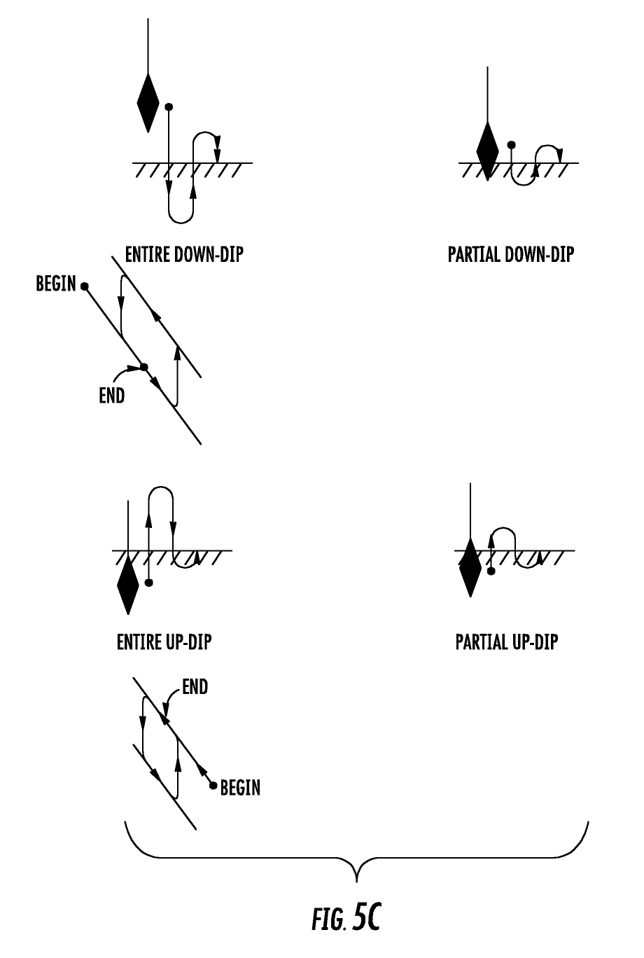

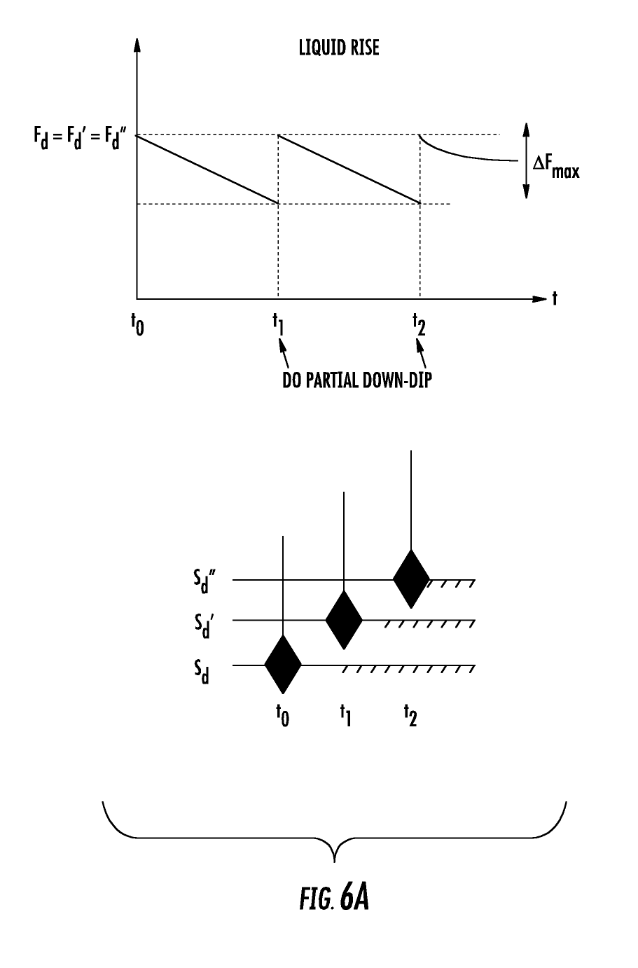

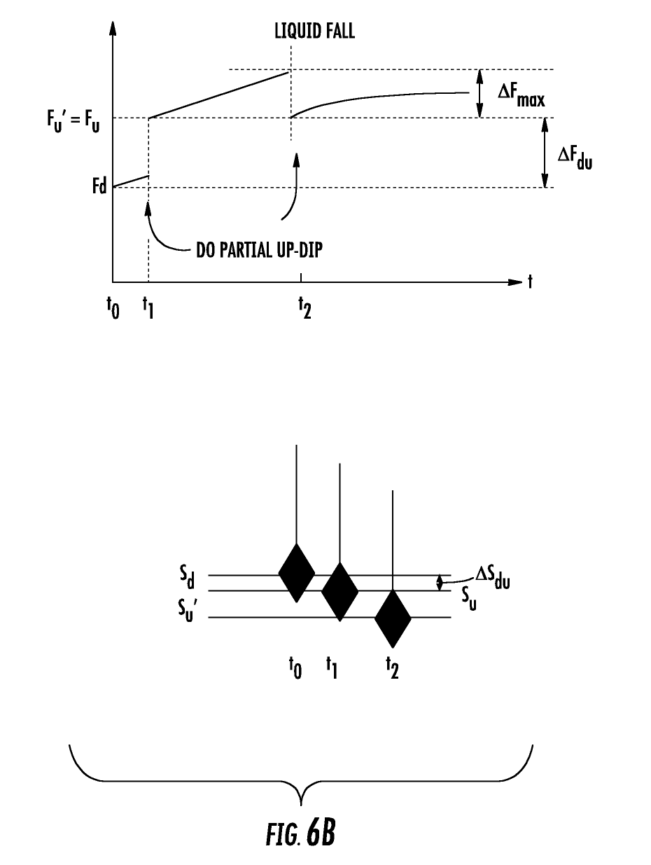

Because the behavior of F is different for rise and fall of the liquid, there is a disclosed process referred to herein as “hysteresis equalization”. After disclosed hysteresis equalization, the displacer will be held at that position. The force F will now only change if the level of the liquid will rise or fall, referred to herein as “hold and correct”. FIG. 5A described below shows two “hold and correct” regions where the hold and correct mechanism includes fixing the position of the displacer for calculation of the corrected level of the liquid referred to herein as Lc.

FIG. 1B is a block diagram illustration the ESG 100 in FIG. 1A, according to an example embodiment. As shown in FIG. 1B, the ESG 100 can included three compartments, a drum compartment 240a, a drive compartment 245a, and a power supply compartment 222a. The drum compartment 240a includes the drum 240 on which a wire 238 is wound. The drum 240 can be rotated in one direction by the drive compartment 245a to lower the displacer 235, and the drum 240 can be rotated in another direction by the drive compartment 245a to raise the displacer 235. The drum 240 includes any suitable structure for raising and lowering the displacer 235 via rotation.

The drive compartment 245a includes a motor 245 including a drive train 246, which imparts rotation to the drum 240 via a shaft 249. For example, the drive train 246 or shaft 249 could generate a magnetic field, and a magnetic coupling 247 can be used to convey torque between the shaft 249 and the drum 240. In these embodiments, no direct connection may be needed between the drum compartment 240a and the other compartments 245a, 222a.

However, other techniques for causing rotation of the drum 240 can be used, such as when the shaft 249 is physically connected to the drum 240. The drive train 246 includes any suitable structure for imparting rotation to the drum 240. In particular embodiments, the drive train 246 comprises a stepper motor that causes the drum 240 to rotate in specified steps, meaning the drum 240 does not rotate freely but instead in defined amounts or “steps.” Each step of the motor 245 should therefore impart a known amount of rotation to the drum 240. In these embodiments, since the drum 240 has a known diameter or circumference, the length of connector the wire 238 that is dispensed or collected during a single step rotation can be known with a high degree of certainty.

The drive compartment 245a also includes a force transducer 225 which identifies the torque induced on the drum 240 by the weight of displacer 235. When the displacer 235 is dangling from the wire 238, the measured torque is higher. When the displacer 235 is completely or partially submerged in the material in the tank, the measured torque is lower. The force transducer 225 generally identifies the torque on the drum 240 by measuring the torque on the shaft 249. The drive compartment 245a is also shown including a user interface 218 and network interface 220.

The power supply compartment 222a includes a power supply 222, which provides operating power for the ESG 100. The power supply 222 can provide power to various components of the drive compartment 245a. Depending on the implementation, the power supply 222 may or may not supply power to the drum compartment 240a. The power supply 222 can include any suitable structure for providing power, such as a battery, fuel cell, or solar cell.

As described above, a significant advantage of disclosed ESGs is the increase of accuracy of the liquid level measurement by elimination of the hysteresis independent of the specific ESG or/and its stage in its lifetime. Additional advantages include automatic density measurement of the liquids.

Regarding the measurement of the density of the liquid(s) by an entirely submerged displacer 235, the densities ρ of the liquid(s) can be calculated from the positions where the displacer is entirely submerged in the liquid.

$$ρ = {ρ}_{dis} - \frac{F}{{V}_{dis} g}$$

Regarding calculation of accuracy increase using other displacer shapes, the accuracy of S_{corrected} is recognized to depend on the radius of the middle assumed cylindrical shaped part of the displacer because:

$$Δ S = \frac{Δ F}{π {r}^{2} ( {ρ}_{high} - {ρ}_{low} )}$$

The displacer's radius (r) can be increased with a displacer that has a density closer to the densities of the liquid(s) in the tank in combination with the length of the displacer. A generally good combination can be the displacer material being aluminum with a density of 2.7 g/cm³. The density can be reduced by a factor of 2 using a hollow displacer since the liquid densities are usually below 1.0 g/cm³ (water). A displacer length of 20 mm and 55 mm radius results in an impressive accuracy increase of 7.5. The absolute accuracy is usually in Newton per mm, but this is unit-less because it compares two accuracy rates of which one is x times higher than the other compared to 250 gram displacers with a radius of 25 mm for all interface exchanges.

However, interface exchanges between liquids have lower accuracy compared to air/liquid exchanges measured with an identical shaped displacer, because of the differences between the densities. There use of displacer's density as an ESG design parameter for the displacer is believed to be another new feature. A further advantage is the ability for a continuously measured liquid density to be correlated with the shape of the displacer to provide enhanced diagnostic information enabling preventive maintenance (detecting displacer contamination), and increased safety.

Reducing the need for ESG movements provided by electronic level correction as described above has several advantages, including longer lifetime for the ESG as automatic level adjustments reduce motor wear, and lower power consumption which can be important when for example by supplied power by solar power. Instead of conventionally continuously recalculating the level set point and trying to keep the immersion depth of the displacer constant (using the servo motor 245 to rotate the measuring drum 240), it is also possible perform a virtual (electronic) correction to the level reading. The same method can even be used to reduce normal servo movements as result of normal level changes.

Regarding a physical analysis for operation of an ESG to which disclosed embodiments can be applied, the displacer 235 for an ESG such as ESG 100 has a mass M_{dis} which as described above is mounted on a measuring wire 238 (also called a cord) in a tank 202 having at least one liquid therein. The force of gravity F_{dis} on the displacer 235 will be M_{dis}·g where g is the acceleration constant (gravity) at the earth's surface (g=9.8 m/s′2).

F_{dis}=M_{dis}g

Archimedes law states that the displacer 235 with a volume V_{dis} and a mass M_{dis} surrounded with a liquid with density ρ in kg/m² is forced downward toward the ground with a force F which is smaller than the force of gravity applied on the displacer 235 by a factor ρ·V_{dis}·g.

F= [symbol] (M [symbol] _{dis}−ρ·V_{dis})g

The displacer's 235 density that is selected (typically >2.0 g/cm³) to be significantly higher than the density of most liquids (typically <0.8 g/cm³) stored in the storage tank, so that the displacer 235 will always be forced toward the ground (i.e., bottom of the tank 202). The liquid's density ρ can thus be found from the measurement of F if the displacer 235 is entirely immersed in the liquid as all other parameters in the F equation are known parameters. Alternatively,—the density can be measured with an entire dip. Both an up-dip and down-dip are possible as both of these dips places the displacer entire above and in the liquid, only the sequence being different. The entire dip is typically conducted frequently and only in a steady-state tank (i.e., very low rate of change in the level, noted above to be ≤0.1 mm/sec), so there is essentially no pumping in/out, but because of daily temperature changes may shrink or expand the tank and the liquid.

Regarding disclosed level correction, as noted above, disclosed displacers can optionally be symmetrically-shaped to make the FS profile linear and thus easier to analyze. The displacer 235 is moved through the liquid level (full dip or only a partially dip) and the servo motor 245 will control displacer movements to follow the move-up or move-down curve and stop moving the displacer 235 if the reduced force is becoming stable (i.e., not changing, except for the density increase of the liquid itself which can be neglected). In that case the displacer 235 is entirely under the interface level. The interface can be between air and a liquid, or between different liquids that have different densities.

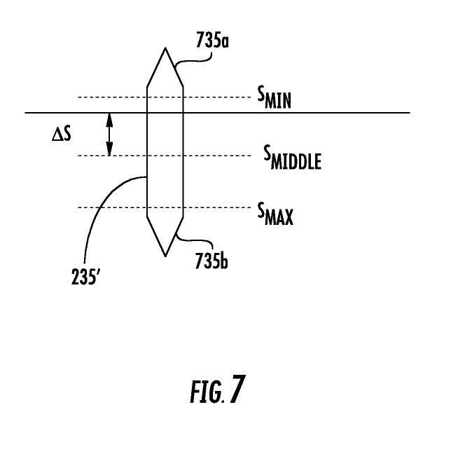

To obtain a straight line between the corner points in the move-up curve and move-down curve of the FS profile (except for the corners), the shape of the displacer 235 is recognized to need to be symmetrical. A symmetrical shape is however not required if a straight line is not needed. An example displacer 235′ having a symmetrical shape is shown in FIG. 7 described below.

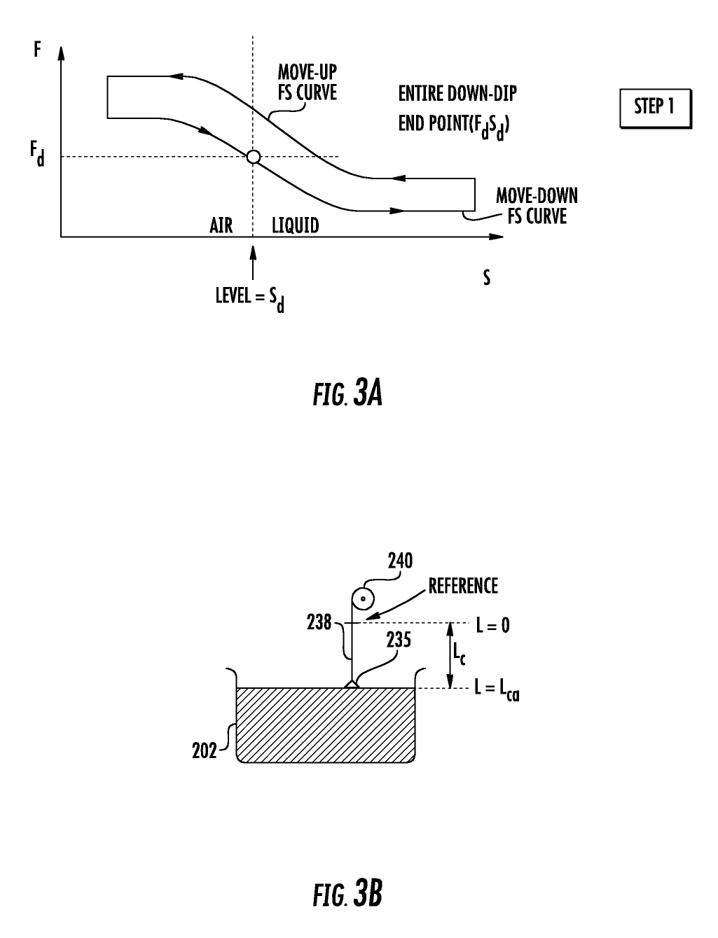

FIG. 2 shows a point on a move-down FS curve (Fd, Sd) and a point on a move-up curve (Fu, Su). The respective curves can be aligned with Fu=Fd+ΔFdu (aligning the force F) and Su=Sd+ΔSdu (aligning the position S). The ΔF and ΔS values can thus be measured by determining the move-down curve and the move-up curve. The hysteresis sets in due to a displacer movement direction change, where the move-up dips end in the Fu, Su location and the move down-dips end in the Fd, Sd location. The Δ's are only generally valid near the center of the curves.

The level measurement accuracy of a conventional current ESG is ½ΔSdu while disclosed ESGs implementing disclosed methods which closely follow the FS curves are much more accurate (by a factor 10 or more). The position of the displacer 235 can be calculated by a disclosed algorithm (taking the corner points Smin, Smax and calculating the middle) where as described above, Sd is the middle of the displacer when moving down, and Su being the middle of the displacer when moving up. As noted above, the position of the displacer is calibrated based on either the calculated Sd or Su value, which being the center of the displacer essentially exactly corresponds with the interface level of the liquid in the tank.

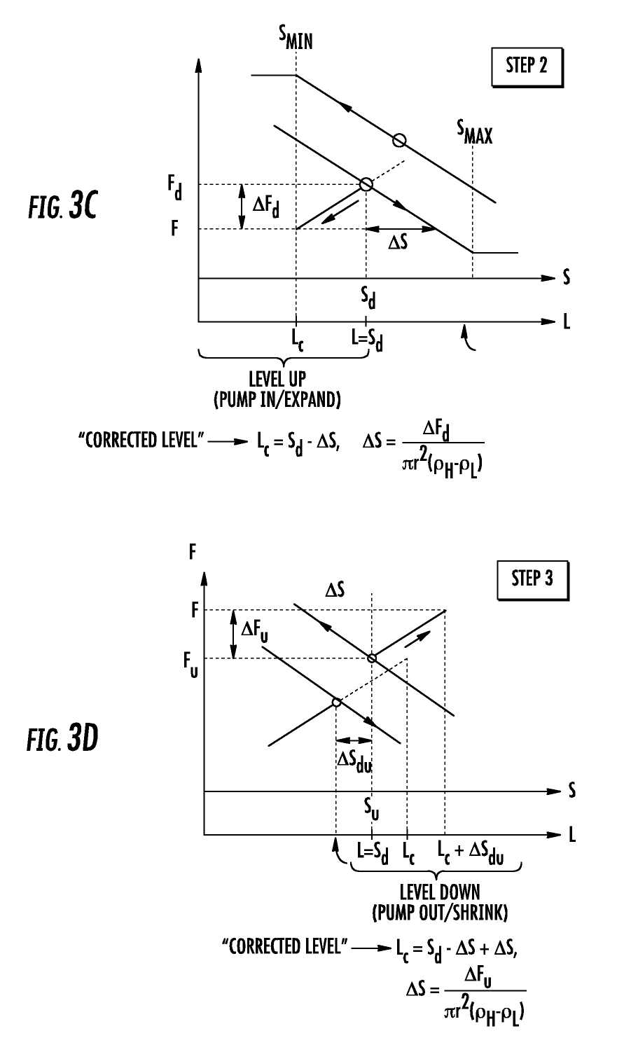

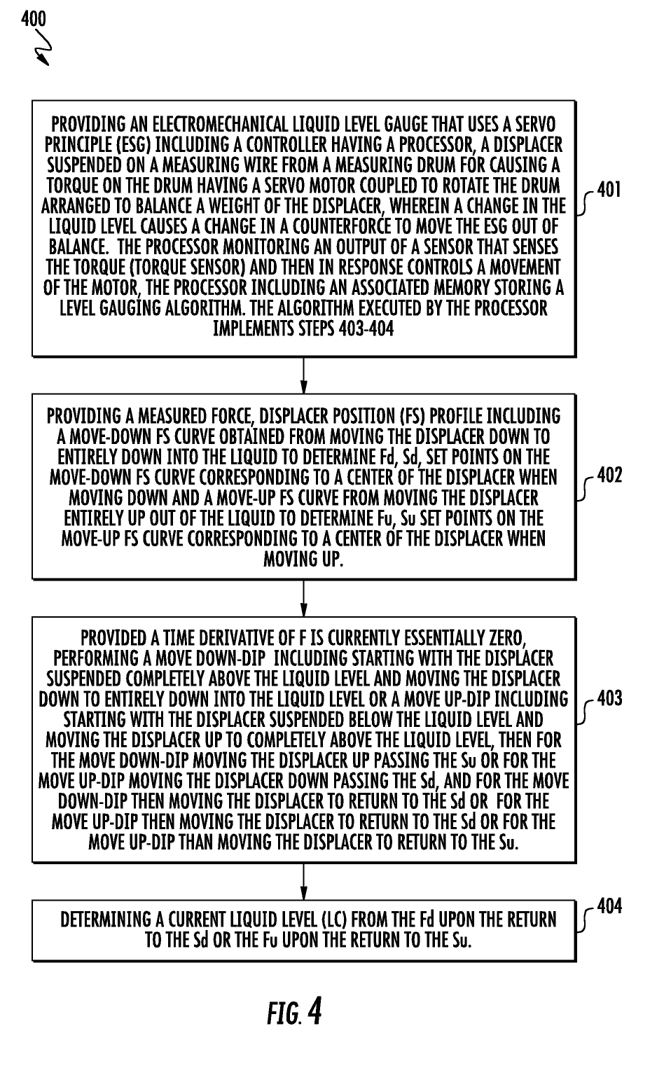

FIG. 3B shows how L is defined herein with displacer 235 shown on a measuring wire 238 from a drum 240. Lc is the corrected liquid or interface level. Regarding L=0 in FIG. 3B, when L=0 it corresponds to a reference point relative to the tank with on top the Servo Gauge. FIGS. 3A, C-D show example move-up and move-down FS curves of an entire down-dip shown as step 1, S correction shown as step 2 where the ΔF=Fd−F is measured and the corresponding ΔS is calculated and added to the Sd determined by the profile FS analysis to get the liquid level (=Lc), and a partial up-dip shown as step 3, respectively. F is the measured force provided by the ESG. The Smin and Smax parameters shown in FIGS. 3C and 3D are the corner points (respective S edges) of the FS-profile. Smin and Smax are directly related to the shape of the displacer. L is always in the range from Smin to Smax.

In FIG. 3A the point Fd, Sd is shown as being at an endpoint for an entire down-dip. In FIG. 3C, a corrected L value (Lc) is shown calculated for the liquid level rising (which can be due to a pump in or an expansion of liquid volume) from the measured ΔFd=Fd−F. Since the last FS profile analysis was done with as a result an Fd, Sd, the change in force is Fd−F (level rise), so that the displacer is more in the liquid which decreases the F, so Fd−F>0. The density values ρ_{H} and ρ_{L} can be derived by the profile analysis (side flanks). Smin and Smax are shown in FIG. 3C. In FIG. 3D, a corrected L value (Lc) is shown calculated for the liquid level falling (pump out or shrinkage of the volume of the liquid in the tank caused by a temperature decrease) as Sd+ΔS from the measured ΔFu=F−Fu and the respective density values as ρH and μL.

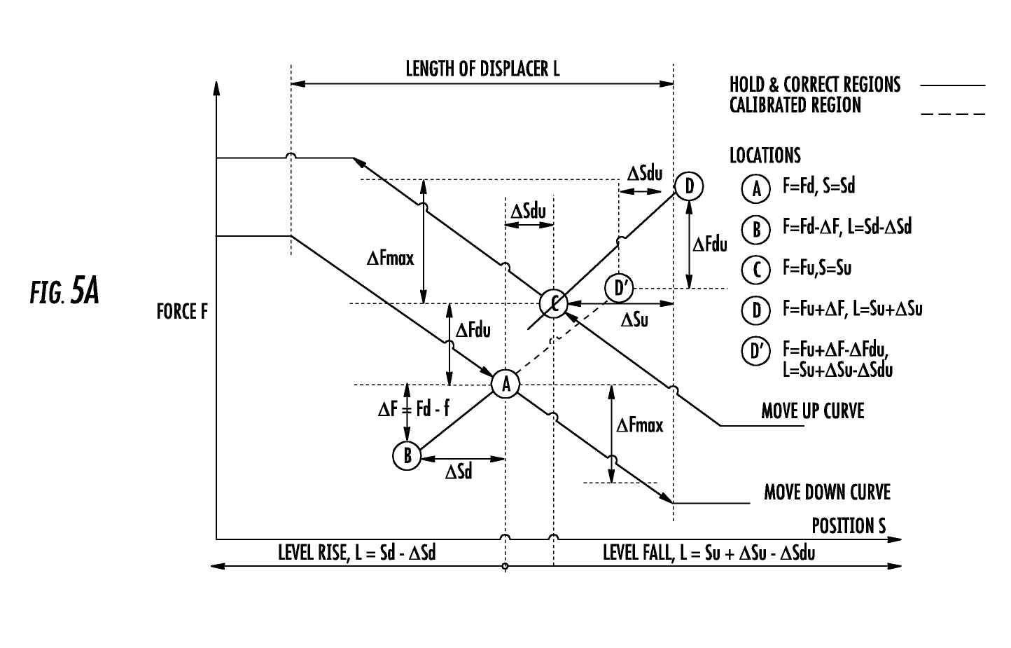

FIG. 4 is a flow chart for an example automatic hysteresis compensated method 400 of level measuring a level in a storage tank. Step 401 comprises providing an ESG including a controller having a processor, a displacer with a negative buoyancy suspended on a measuring wire from a spiral grooved measuring drum for causing a torque on the drum having a servo motor with a gear (motor) coupled to rotate the drum arranged to balance a weight of the displacer, wherein a change in the liquid level causes a change in a counterforce to move the ESG out of balance. The processor monitors an output of a sensor that senses the torque (torque sensor) and then in response controls a movement of the motor. The processor includes an associated memory storing a level gauging algorithm. The algorithm executed by the processor implements steps 403-404 described below.

Step 402 comprises providing a measured FS profile including a move-down FS curve obtained from moving the displacer to entirely down into the liquid down to determine Fd, Sd corresponding to a center of the displacer when moving down and a move-up FS curve from moving the displacer entirely up out of the liquid to determine Fu, Su corresponding to a center of the displacer when moving up. The FS profile is used to measure the level of the liquid by measuring the changes in the frequency to be converted to a force F. After an FS profile measurement, all previous profile measurements are not included in the determination of the last Fd, Sd point as the FS profile measurement resets all measurement results and provides an accurate new level set point Sd (or Su) which corresponds to the level of the liquid directly after the FS profile determination.

Step 403 comprises provided a time derivative of F is essentially zero, performing an at least a partial down-dip of the displacer including starting with the displacer suspended completely above the liquid level, moving the displacer down to below the liquid level, then moving the displacer up passing Su, and then moving the displacer to return to Sd. Step 404 comprises determining a last interface level of the liquid from Fd upon its return to Sd.

Responsive to a predetermined minimum rise in the liquid level wherein the displacer is fixed at set point Sd and the level follows the hold and correct region mirrored at the move-down FS curve from set point (Fd, Sd), a partial move-down of the displacer is performed to determine an updated Fd value to provide an even further updated liquid level. The predetermined minimum rise in liquid level can correspond to Fd−F equal to an ΔFmax value equal to Fd−Fmin, wherein Fmin is the F value when S equals an Smax value which is a corner point on the FS profile. (See Smax in FIG. 3C). The method can also comprise responsive to a predetermined minimum drop in the liquid level where the displacer is fixed at set point Su and the level will follow the hold and correct region (fat line in FIG. 3D) mirrored at the move-up FS curve form set point (Fd,Sd), further comprising performing a partial move-up of the displacer to determine an updated Fu value to provide an even further updated liquid level. After a projection on the move-down FS curve (dashed line in FIG. 3D as a reference curve), the liquid level Lc=Sd+ΔS. The predetermined minimum drop in liquid level can correspond to F−Fu equal to a ΔFmax value that equals the F when S equals a Smin value which is a corner point on the FS profile. (See Smin shown in FIG. 3C).

The displacer can be a symmetrically-shaped displacer (see displacer 235′ in FIG. 7 described below). In that case, the method can further comprise calculating Sd as Sd=Smin+(Smax−Smin)/2, wherein Smin and Smax are corner points on the FS profile, Smin corresponding to a position of the displacer when the displacer is touching the liquid, and Smax corresponding to when the displacer is below the liquid level except for only a hat shaped end of the displacer.

FIG. 5A shows an example FS profile for a displacer in a tank for a range of travel showing a disclosed move-down curve and a disclosed move-up curve, with the differences in the respective curves evidencing the hysteresis. The S-axis uses the convention where position of the displacer (S) is defined to increase as it approaches the bottom of the tank. If the displacer is changing direction (up to down, or down to up) the hysteresis effect sets in and results in a change (Δ) in F and a Δ in S. Hold and correct regions A, B, C, D and D′ are shown. These lines are followed if the displacer's position is fixed at Sd or Su and the level of the liquid Lc is corrected by Sd−ΔS for a liquid level rise and by Sd+ΔS for a liquid level drop. Location D′ is the projection of location D on the calibrated move down-curve by applying F′=F−ΔFdu and S′=S−ΔSdu (dashed line).

FIG. 5B is an example state diagram showing a more detailed description of the respective states (shown as locations A, B, C, and D on the hysteresis curves which correspond to locations A, B (on the move-down curve), and C and D (on the move-up curve) all shown in FIG. 5A the displacer can be in and under what conditions the several disclosed defined dips are set in. For example, location A in FIG. 5A corresponds to the state “Location A on move-down curve where F=Fd and S=Sd” in FIG. 5B. An entire down-dip 510 as described above is performed when the level is essentially unchanging (dF/dt=0 or essentially zero), corresponding to a very low rate of change in the level defined as ≤0.1 mm/sec, such as <0.01 mm/sec, so there is no pumping in/out. The displacer is thus on the move-down curve, and F=Fd and S=Sd. Sd is at the interface after the FS profile analysis but not a time period later, then the force change will correct the level of the liquid Lc=Sd+ΔS where Sd is the calculated level set point after an entire or partial move down-dip.

If the liquid level rises (pumping in or volume expansion of liquid) the level of the liquid will follow the mirrored move-down curve until Fd−F>ΔFmax. Then the method performs a partial down-dip 515 to move from location B to location A back on the move-down curve obtain a new Sd value. The current liquid level is now equal to the new Sd value where Sd is the calculated set point at the new location A. A dips results in a new Sd and a new Su. This will become the new set point where the displacer's middle is moved to Sd=Smin+(Smax−Smin)/2 (for a symmetrical shaped displacer such as displacer 235′ shown in FIG. 7).

If the liquid level drops (pumping out or shrink of the liquid) the level of the liquid will follow the mirrored move-up curve. A partial up-dip 520 is then performed to get the displacer solidly on the move-up curve shown as being at location C. The level of the liquid Lc will follow the move-up curve until F−Fu>ΔFmax which will move location D to location C by performing a partial move-up dip reaching location D on the move-up curve. Then a partial up-dip 525 is used for making a transition from location D to location C is then performed to obtain a new Su value, where the current liquid level is now equal to the new Su value. The real liquid level is always on the mirrored move-down curve because the real level as described herein is calibrated for this. Accordingly, the corrected liquid level Lc=Su−ΔSdu+ΔS. However, as described above choice to calibrate on move-down curve is a design choice, so that one can also calibrate using the move-up curve.

Significant disclosed features shown include the x minutes condition shown while at location A, B, C or D where an entire up-dip or down-dip can be used to provide updated FS curves to provide an updated ΔFdu and updated ΔSdu. This overcomes the effect of increasing static friction along time which would otherwise result in hysteresis-based errors which is recognized to be generally important in steady state level changes. The x minute condition for location A and C will end up in location A and C itself, while the x minute condition for location B and D will result in location A and C, respectively.

Partial dips above may be repeated if sensed level changes from changes in F result in when a ΔF value is >a predetermined ΔFmax value. Trigger partial dips when Fd−F>ΔFmax for level rising (partial move-down) and Fd−F>ΔF max for level drops (partial move-up).

FIG. 5C shows the four dip-types disclosed herein and their relation between the movements of the displacer (S) and the corresponding F, the start locations (above or below the liquid), the effect of the direction change, and the end location. The partial dips have smaller movement lengths and the start location can also vary on the first movement arrow track. For a partial down-dip the start location can be below the liquid level but the direction is always going down at first. For the entire dips the displacer always starts entirely below or above the liquid.

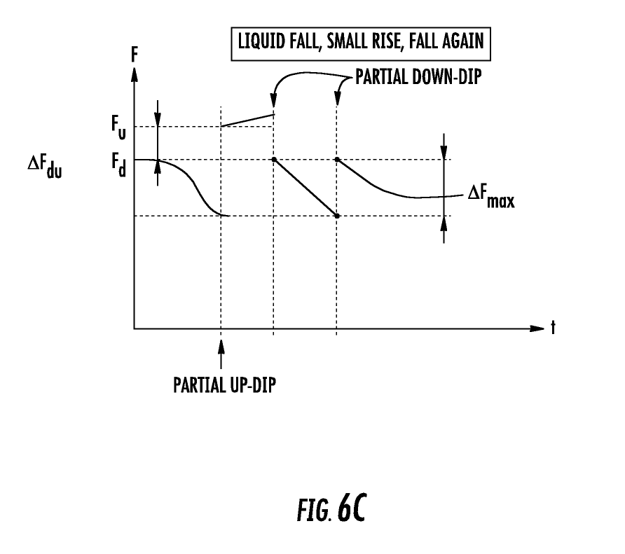

FIGS. 6A-C show F changes with time and partial dips taking place due to dF(t)/dt changing caused by the rise or fall of the liquid in the tank. Three main scenarios are shown, with liquid rise shown in FIG. 6A, liquid fall shown in FIG. 6B and liquid rise with in-between fall shown in FIG. 6C.

### Examples

Disclosed embodiments are further illustrated by the following specific Examples, which should not be construed as limiting the scope or content of this Disclosure in any way.

FIG. 7 shows an example displacer 235′ having a symmetrical shape. The displacer 235′ has two hat shape ends 735a and 735b to enable it move easier through liquids. As noted above, symmetrically-shaped displacers such as displacer 235′ have the advantage of making the FS profile linear and thus easier to analyze.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

1. An automatic hysteresis compensated method of level measuring a liquid in a storage tank, comprising:
providing an electromechanical liquid level gauge that uses a servo principle (ESG) including a controller having a processor, a displacer suspended on a measuring wire from a measuring drum for causing a torque on said drum having a servo motor coupled to rotate said drum arranged to balance a weight of said displacer, wherein a change in a liquid level causes a change in a counterforce to move said ESG out of balance, said processor monitoring an output of a sensor that senses said torque (torque sensor) and then in response controls a movement of said motor, said processor including an associated memory storing a level gauging algorithm;
providing a measured force (F) displacer position (FS) profile including a move-down FS curve obtained from moving said displacer down to entirely down into said liquid to determine Fd, Sd set points on said move-down FS curve corresponding to a center of said displacer when moving down and a move-up FS curve from moving said displacer entirely up out of said liquid to determine Fu, Su set points on said move-up FS curve corresponding to said center of said displacer when moving up;
said algorithm executed by said processor implementing:
provided a time derivative of said F is currently essentially zero, performing a move down-dip including starting with said displacer suspended completely above said liquid level and moving said displacer down to entirely down into said liquid level or a move up-dip including starting with said displacer suspended below said liquid level and moving said displacer up to completely above said liquid level, then for said move down-dip moving said displacer up passing said Su or for said move up-dip moving said displacer down passing said Sd and for said move down-dip then moving said displacer to return to said Sd or for said move up-dip then moving said displacer to return to said Su, and
determining a current liquid level (Lc) from said Fd upon said return to said Sd or said Fu upon said return to said Su.

2. The method of claim 1, wherein responsive to a predetermined minimum rise in said liquid level, wherein said S is fixed in said Sd and follows a FL curve that comprises said move-down FS curve mirrored over an x-axis for said S equal to said Sd, further comprising performing a partial move-down of said displacer to determine an updated Fd value to provide an updated Lc.

3. The method of claim 2, wherein said predetermined minimum rise in said liquid level corresponds to said Fd−said F equal to an ΔFmax value, said ΔFmax value equal to said Fd−Fmin, wherein said Fmin is said F when said S equals an Smax value which is a corner point on said move-down FS curve.

4. The method of claim 1, wherein responsive to a predetermined minimum drop in said liquid level, wherein said S is fixed on said Su, and follows a FL curve that comprises said move-up FS curve mirrored over an x-axis for said S equal to said Su, further comprising performing a partial move-up of said displacer to determine an updated Fu value to provide an updated Lc.

5. The method of claim 4, wherein said predetermined minimum drop in said liquid level corresponds to said F−said Fu equal to an ΔFmax value, said ΔFmax value equal to said Fmax−said Fu, wherein said Fmax is said F when said S equals an Smin value which is a corner point on said move-up FS curve.

6. The method of claim 1, wherein said displacer is a symmetrically-shaped displacer.

7. The method of claim 6, further comprising calculating said Sd as Sd=Smin+(Smax−Smin)/2, wherein said Smin and Smax are corner points on said FS profile, said Smin corresponding to a position of said displacer when said displacer is touching said liquid, and said Smax corresponding to a position of said displacer when said displacer is below said liquid level except for only a hat shaped end of said displacer.

8. An electromechanical liquid level gauge that uses a servo principle (ESG) for level measuring a liquid in a storage tank, comprising:
a controller having a processor;
a displacer suspended on a measuring wire from a spiral grooved measuring drum for causing a torque on said drum having a servo motor with a gear (motor) coupled to rotate said drum arranged to balance a weight of said displacer, wherein an equilibrium condition exists when said displacer is partly submerged into said liquid, wherein a change in liquid level causes a change in a counterforce to move said ESG out of balance;
said processor for monitoring an output of a sensor that senses said torque (torque sensor) and then in response controls a movement of said motor, said processor including an associated memory storing a level gauging algorithm;
a measured force (F) displacer position (FS) profile provided to said ESG including a move-down FS curve obtained from moving said displacer down to entirely down into said liquid down to determine Fd, Sd set points on said move-down FS curve corresponding to a center of said displacer when moving down and a move-up FS curve from moving said displacer entirely up out of said liquid to determine Fu, Su set points on said move-up FS curve corresponding to said center of said displacer when moving up;
said algorithm executed by said processor implementing:
provided a time derivative of said F is essentially zero, performing a down-dip of said displacer including starting with said displacer suspended completely above said liquid level and moving said displacer down to entirely down into said liquid level or an up-dip of said displacer including starting with said displacer suspended below said liquid level and moving said displacer up to completely above said liquid level, then for said down-dip moving said displacer up passing said Su or for said up-dip moving said displacer down passing said Sd, and for said down-dip then moving said displacer to return to said Sd or for said up-dip then moving said displacer to return to said Su, and
determining a current liquid level from said Fd upon said return to said Sd or said Fu upon said return to said Su.

9. The ESG of claim 8, wherein responsive to a predetermined minimum rise in said liquid level wherein said S is fixed in said Sd and follows a FL curve that comprises said move-down FS curve mirrored over an x-axis for said S equal to said Sd, said algorithm further implementing performing a partial move-down of said displacer to determine an updated Fd value to provide an updated Lc.

10. The ESG of claim 9, wherein said predetermined minimum rise in said liquid level corresponds to said Fd−said F equal to an ΔFmax value, said ΔFmax value equal to said Fd−Fmin, wherein said Fmin is said F when said S equals an Smax value which is a corner point on said move-down FS curve.

11. The ESG of claim 8, wherein responsive to a predetermined minimum drop in said liquid level wherein said S is fixed on said Su, and follows a FL curve that comprises said move-up FS curve mirrored over an x-axis for said S equal to said Su, said algorithm further implementing performing a partial move-up of said displacer to determine an updated Fu value to provide an updated Lc.

12. The ESG of claim 11, wherein said predetermined minimum drop in said liquid level corresponds to said F−said Fu equal to an ΔFmax value, said ΔFmax value equal to said Fmax−said Fu, wherein said Fmax is said F when said S equals an Smin value which is a corner point on said move-up FS curve.

13. The ESG of claim 8, wherein said displacer is a symmetrically-shaped displacer.

14. The ESG of claim 13, said algorithm further implementing calculating said Sd as Sd=Smin+(Smax−Smin)/2, wherein said Smin and Smax are corner points on said FS profile, said Smin corresponding to a position of said displacer when said displacer is touching said liquid, and said Smax corresponding to a position of said displacer when said displacer is below said liquid level except for only a hat shaped end of said displacer.
